(19) United States
(12) Patent Application Publication
(10) Pub. No.: US 2026/0172927 A1
(43) Pub. Date: Jun. 18, 2026

(54) SEPARATE CELL ACTIVATION/DE-ACTIVATION

(71) Applicant: QUALCOMM Incorporated, San Diego, CA (US)

(72) Inventors: Kianoush HOSSEINI, San Diego, CA (US); Mostafa KHOSHNEVISAN, San Diego, CA (US); Gokul SRIDHARAN, Sunnyvale, CA (US); Aria HASANZADEZONUZY, Chatham, NJ (US); Heechoon LEE, San Diego, CA (US); Kausik RAY CHAUDHURI, San Diego, CA (US)

(21) Appl. No.: 18/981,317

(22) Filed: Dec. 13, 2024

(51) Int. Cl. H04W 36/08; H04L 1/1812; H04W 16/10; H04W 72/21; H04W 76/30

(52) U.S. Cl. CPC H04W 36/08; H04L 1/1812; H04W 16/10; H04W 72/21; H04W 76/30

(57) ABSTRACT

Apparatus, methods, and computer program products for wireless communication are provided. An example method may include receiving, from a network entity, one of a downlink (DL) activation, a DL deactivation, a uplink (UL) activation, or an UL deactivation for a secondary cell, the DL activation, the DL deactivation, the UL activation, or the UL deactivation being separate from each other. The example method may further include communicating with the secondary cell based on the DL activation, the DL deactivation, the UL activation, or the UL deactivation.

### TECHNICAL FIELD

The present disclosure relates generally to communication systems, and more particularly, to wireless communication systems including activation and deactivation of cell(s).

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus at a user equipment (UE) are provided. The apparatus may include at least one memory and at least one processor coupled to the at least one memory. Based at least in part on information stored in the at least one memory, the at least one processor, individually or in any combination, is configured to (e.g., cause the UE to) receive, from a network entity, at least one of a downlink (DL) activation, a DL deactivation, a uplink (UL) activation, or an UL deactivation for a secondary cell, the DL activation, the DL deactivation, the UL activation, or the UL deactivation being separate from each other. Based at least in part on information stored in the at least one memory, the at least one processor, individually or in any combination, is configured to communicate with the secondary cell based on the DL activation, the DL deactivation, the UL activation, or the UL deactivation.

To the accomplishment of the foregoing and related ends, the one or more aspects include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 5 is a diagram illustrating example communications between a network entity and a UE, in accordance with various aspects of the present disclosure.

FIG. 4 is a diagram illustrating example medium access control (MAC) control element (MAC-CE) for coupled deactivation/activation, in accordance with various aspects of the present disclosure.

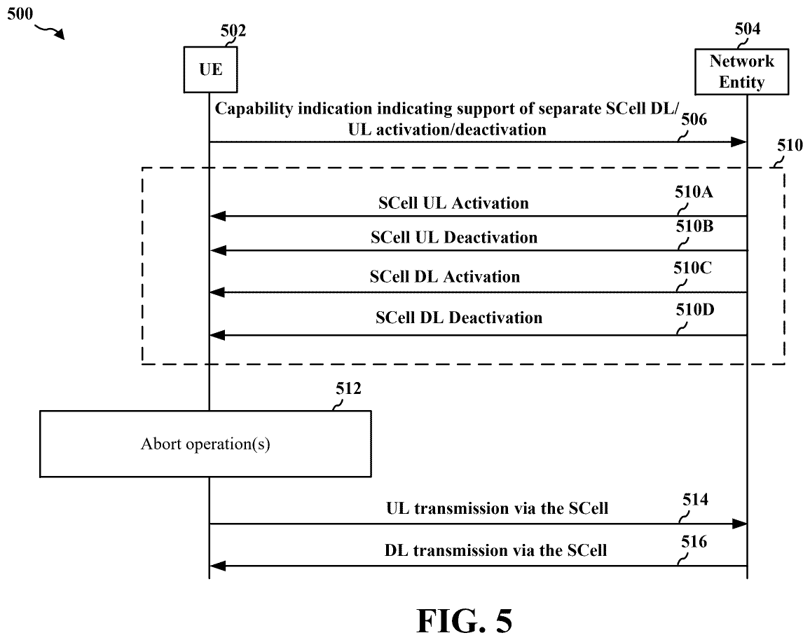

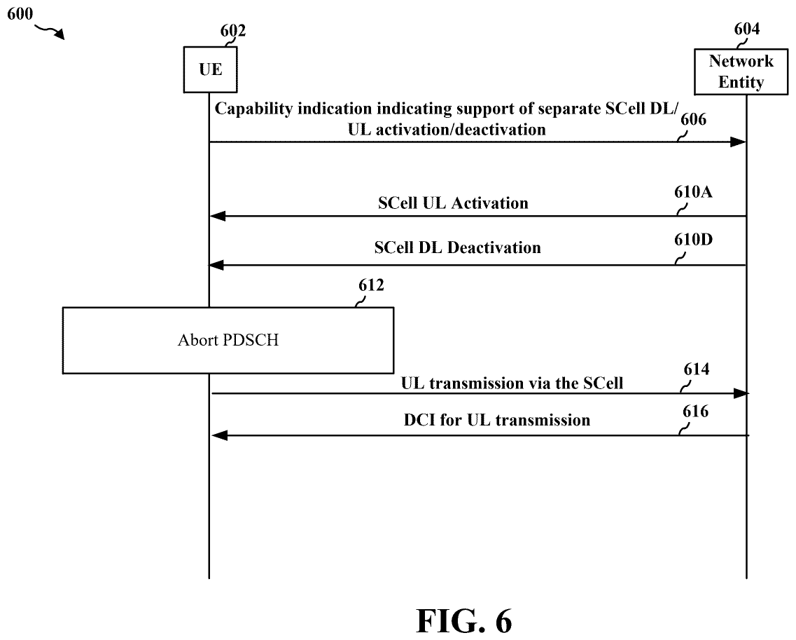

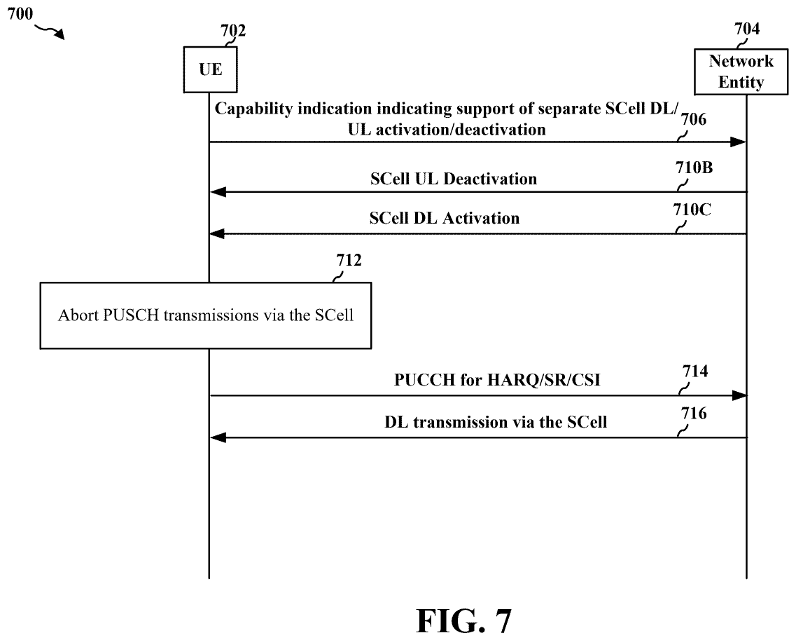

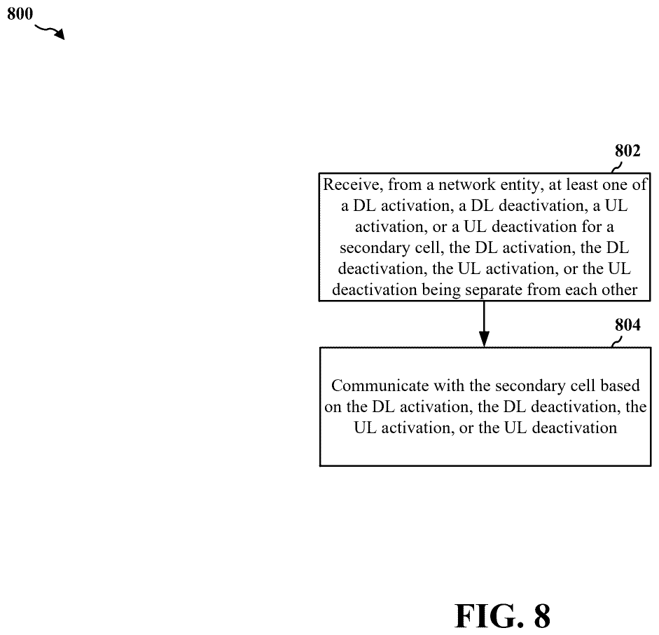

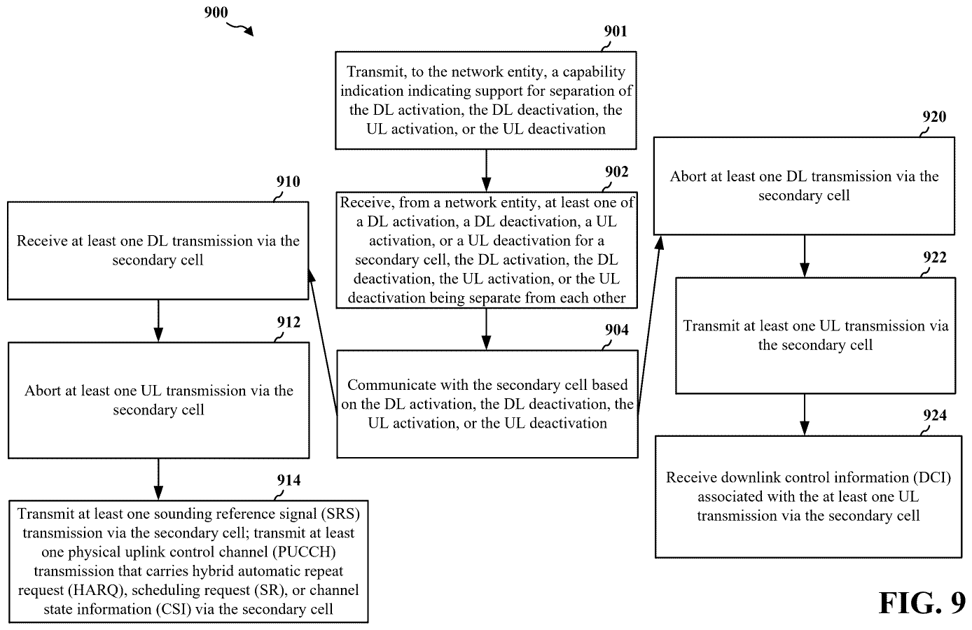

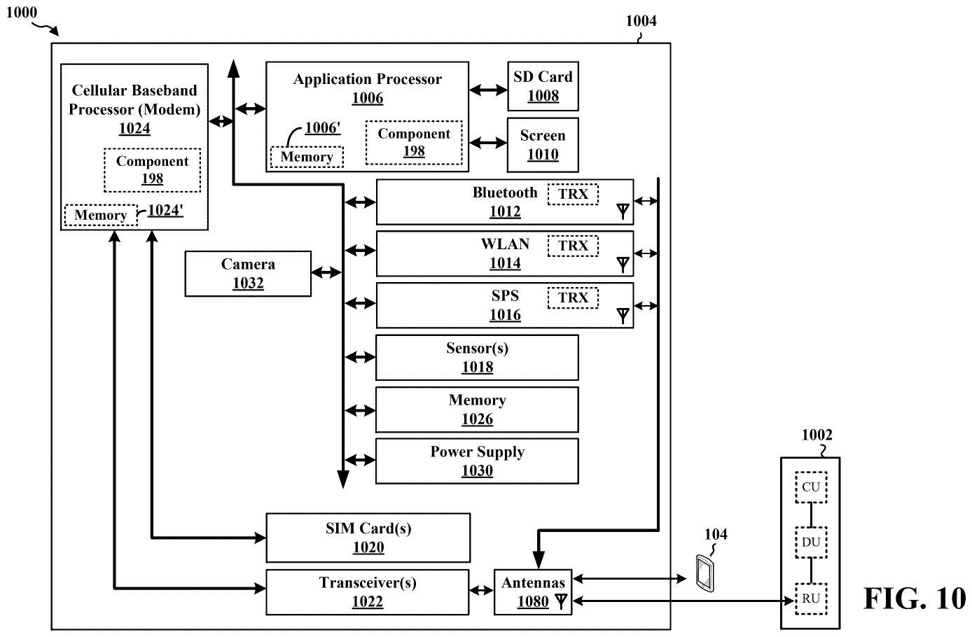

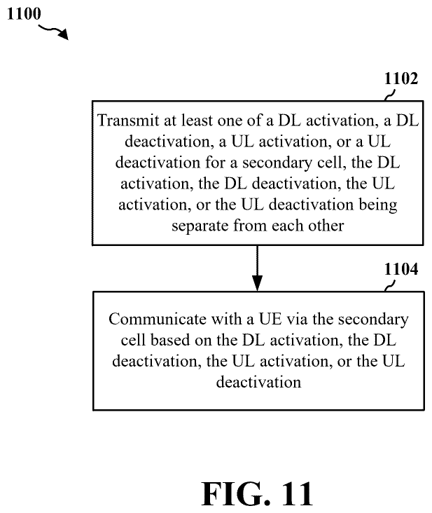

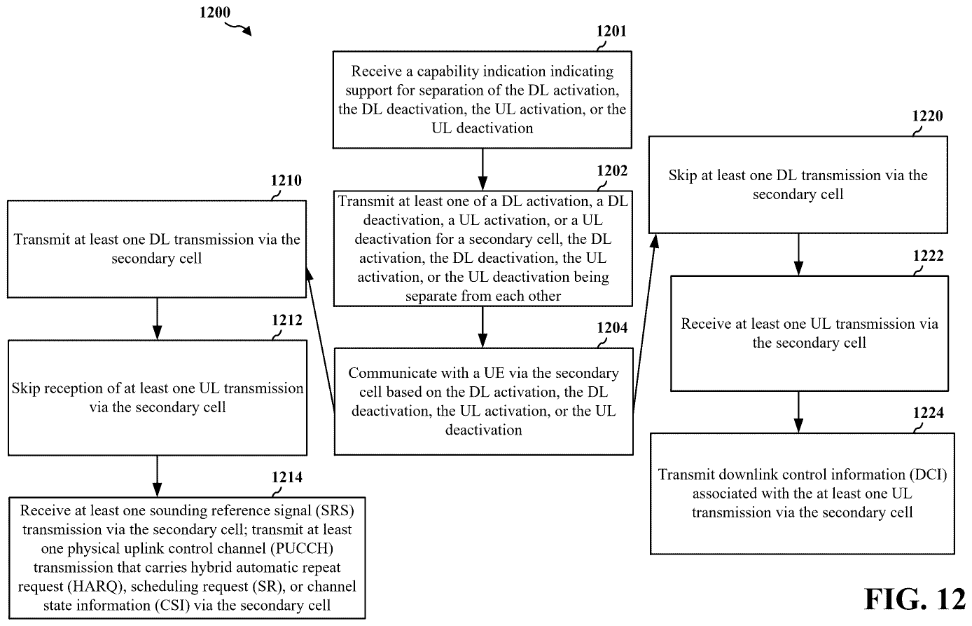

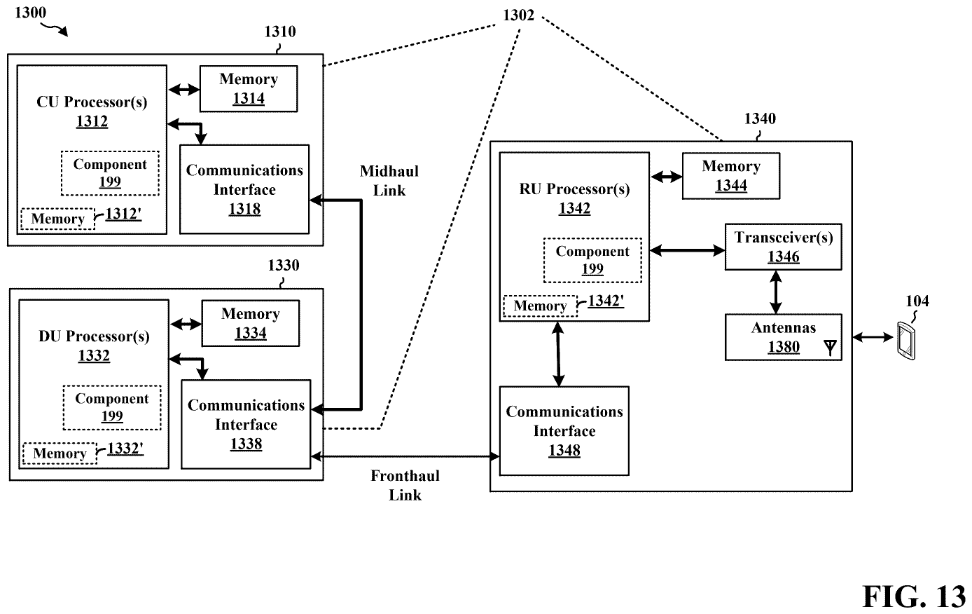

FIG. 5 is a diagram illustrating example communications between a network entity and a UE, in accordance with various aspects of the present disclosure.

FIG. 6 is a diagram illustrating example communications between a network entity and a UE, in accordance with various aspects of the present disclosure.

FIG. 7 is a diagram illustrating example communications between a network entity and a UE, in accordance with various aspects of the present disclosure.

FIG. 8 is a flowchart of a method of wireless communication, in accordance with various aspects of the present disclosure.

FIG. 9 is a flowchart of a method of wireless communication, in accordance with various aspects of the present disclosure.

FIG. 10 is a diagram illustrating an example of a hardware implementation for an example apparatus and/or UE, in accordance with various aspects of the present disclosure.

FIG. 11 is a flowchart of a method of wireless communication, in accordance with various aspects of the present disclosure.

FIG. 12 is a flowchart of a method of wireless communication, in accordance with various aspects of the present disclosure.

FIG. 13 is a diagram illustrating an example of a hardware implementation for an example apparatus and/or network entity, in accordance with various aspects of the present disclosure.

### DETAILED DESCRIPTION

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

In some wireless communication systems, carrier aggregation, secondary cells (SCells) may be configured for a user equipment (UE) once the UE enters the radio resource control (RRC) connected state. These SCells may be activated upon configuration (direct SCell activation) or may be activated (and later de-activated) upon a different scenario. In some wireless communication systems, activation/deactivation of uplink (UL) and downlink (DL) operations are coupled together for an SCell. In other words, if an SCell is de-activated, all DL and UL operations are suspended/stopped/skipped by the UE. Additionally, if an SCell is activated (e.g., due to a large buffer size in one direction), then the UE may perform both DL and UL operations (regardless of paired or unpaired spectrum and regardless of whether it has data to receive or transmit on the other direction). However, considering the varied nature of different applications, it may be beneficial to decouple activation/de-activation across DL and UL to achieve higher efficiency. In some wireless communication systems, by configuration, some SCells may have both DL and UL and some are only for DL (i.e., their PUSCH configuration is not provided). In essence, by configuration, the UE may be configured with a quantity of DL CCs that is greater than or equal to a quantity UL CCs under carrier aggregation.

If more uplink CCs may be used, re-configuration, which may be slow, may be performed. Further, it may be beneficial to activate/de-activate certain operations in each direction based on whether the UE would use the SCell in each direction. Putting a UE in an activated mode for an SCell in both directions may potentially waste power at the UE. For example, if a UE would use an additional bandwidth (BW) in one direction but not the other (this may happen for SCells that are configured in both DL and UL directions), the UE still sets its baseband clock frequency (and possibly radio frequency (RF) BW) with the assumption that both DL and UL will be active even though the network may schedule the UE in one direction without scheduling in the other direction. For example, the network may schedule the UE to receive DL communication without allocating resources for UL communication. Alternatively, the network may allocate resources for the UE to transmit UL transmissions without scheduling DL transmission to the UE. Aspects provided herein may enable a UE to separately activate/deactivate UL/DL for a secondary cell, enabling potentially higher efficiency in the communication and power saving at the UE.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof. One or more processors in the processing system may execute software to cause a device that includes the one or more processors to perform the various functionality described throughout this disclosure.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer (e.g., transitory or non-transitory medium that may be accessed by computer).

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

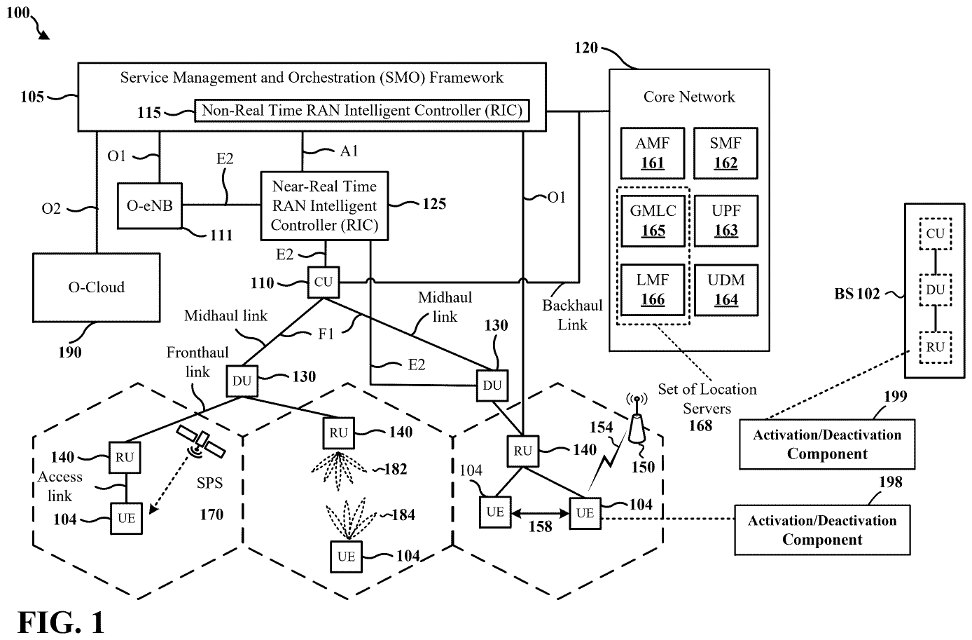

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140. Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in some aspects, the UE 104 may include a activation/deactivation component 198. In some aspects, the activation/deactivation component 198 may be configured to receive, from a network entity, at least one of a downlink (DL) activation, a DL deactivation, a uplink (UL) activation, or an UL deactivation for a secondary cell, the DL activation, the DL deactivation, the UL activation, or the UL deactivation being separate from each other. In some aspects, the activation/deactivation component 198 may be further configured to communicate with the secondary cell based on the DL activation, the DL deactivation, the UL activation, or the UL deactivation.

In certain aspects, the base station 102 may have a activation/deactivation component 199 that may be configured to transmit at least one of a DL activation, a DL deactivation, an UL activation, or an UL deactivation for a secondary cell, the DL activation, the DL deactivation, the UL activation, or the UL deactivation being separate from each other; and communicate with a UE via the secondary cell based on the DL activation, the DL deactivation, the UL activation, or the UL deactivation.

Although the following description may be focused on 5G NR, the concepts described herein may be applicable to other similar areas, such as LTE, LTE-A, CDMA, GSM, and other wireless technologies.

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

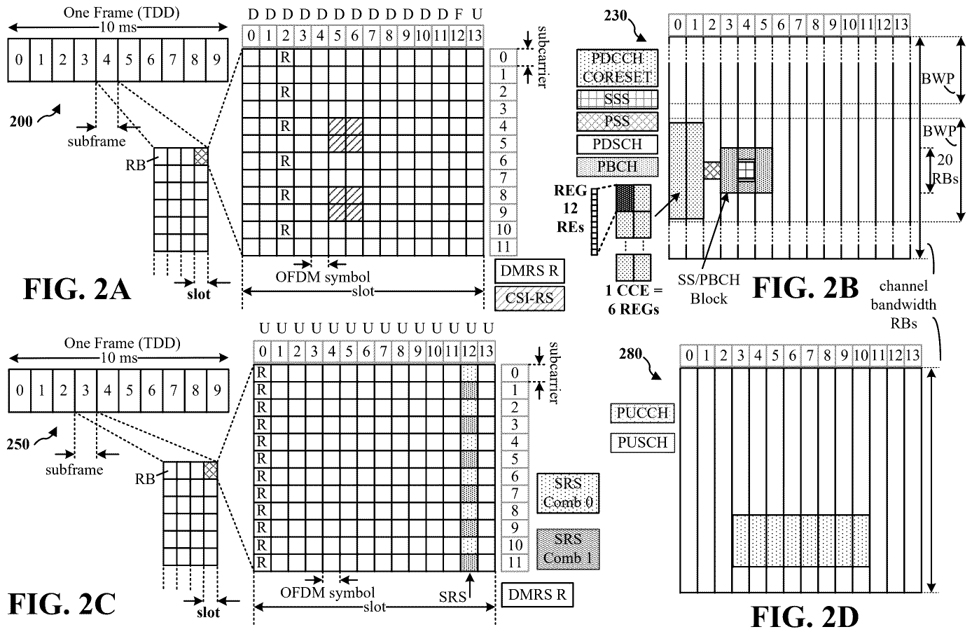

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 2^{μ} slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

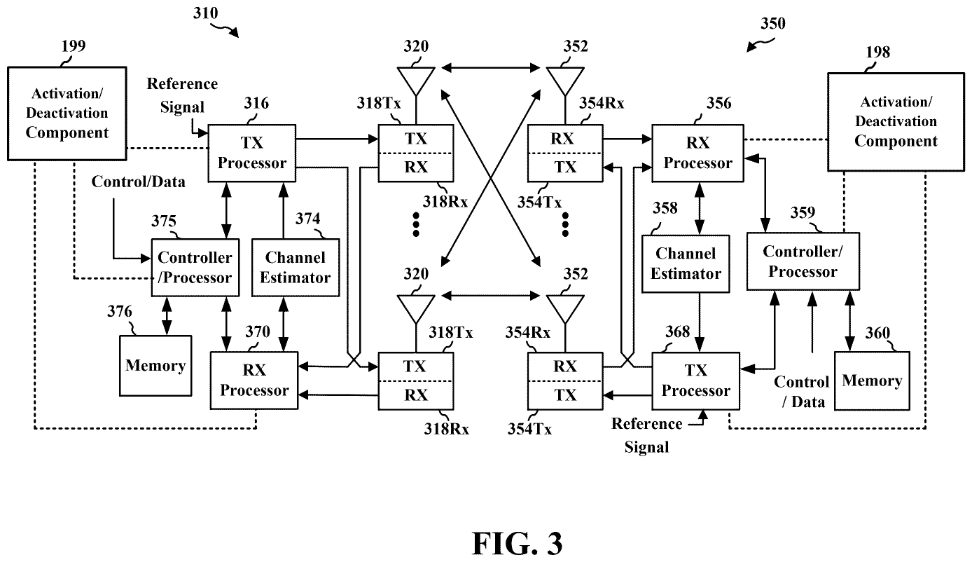

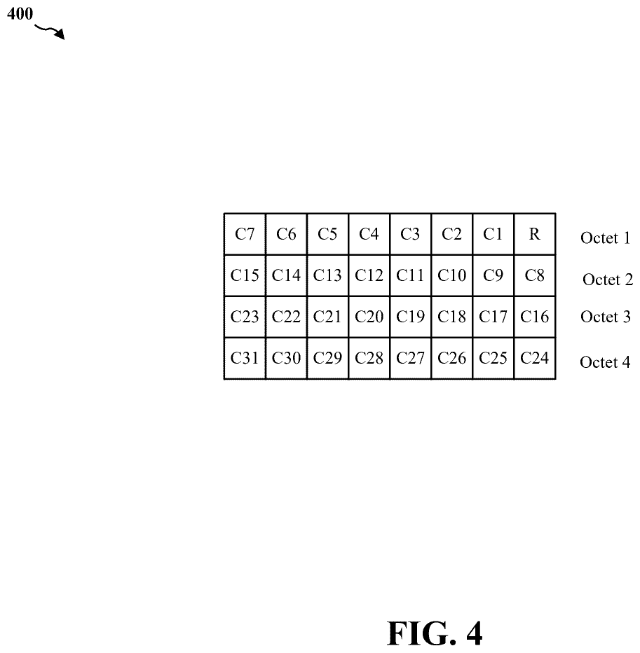

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with activation/deactivation component 198 of FIG. 1.

At least one of the TX processor 316, the RX processor 370, and the controller/processor 375 may be configured to perform aspects in connection with the activation/deactivation component 199 of FIG. 1.

As used herein, the terms “DL activation, a DL deactivation, an UL activation, or an UL deactivation for a secondary cell” may refer to DL or UL deactivation/activation in which the activation or deactivation are indicated separately for UL and DL communication. Such activation or deactivation for DL and UL separately may occupy a standalone field in a medium access control (MAC) control element or may be a separate radio resource control (RRC) parameter (or a field in a DCI). A DL or UL activation/deactivation may be considered to be “separate” if it's possible to activate or deactivate DL operations independently of UL operations for a particular secondary cell (SCell), for example.

For example, for direct activation, separate RRC parameters may be configured for DL and UL, e.g., information element (IE) sCellState_DL and sCellState_UL, which may be set to activated separately. For MAC-CE based activation/de-activation, separate C_i fields can be included for DL and UL separately per cell, e.g., IE C_i_DL and C_i_UL for DL/UL. For fast activation/de-activation via dormant BWP, separate indication(s) may be included in the DCI. Once DL is deactivated for a particular secondary cell (SCell), at least one type of DL transmission on the SCell or for the SCell (which may be collectively referred to as “via the SCell”) may be deactivated. For example, PDSCH reception may be deactivated and the UE may refrain from monitoring for PDSCH receptions. There may also be DL transmission that remains active despite DL being deactivated for the particular SCell. For example, if UL is still active (in other words, activated) for the particular SCell, the UE may still monitor for DCIs that are related to UL transmissions. Once UL is deactivated for a particular SCell, at least one type of UL transmission on the SCell or for the SCell may be deactivated. For example, PUSCH transmission may be deactivated and the UE may refrain from transmitting PUSCH transmissions (e.g., by aborting PUSCH transmissions). There may also be UL transmission that remains active despite UL being deactivated for the particular SCell. For example, if DL is still active (in other words, activated) for the particular SCell, the UE may still transmit PUCCH that are related to the DL transmissions, such as PDSCH receptions, which may include hybrid automatic repeat request (HARQ), scheduling request (SR), or channel state information (CSI) transmissions via the SCell. As used herein, the term “skip” or “suspend” may refer to refrain from transmitting an UL transmission or refrain from monitoring for a DL transmission.

In some wireless communication systems, carrier aggregation, SCells may be configured for a UE once it enters the RRC connected state. These SCells may be activated upon configuration (direct SCell activation) or base state may further activate (and later de-activate) the SCell upon a different scenario. In some wireless communication systems, activation/deactivation of UL and DL operations for an SCell are coupled together. In other words, if an SCell is de-activated, all DL and UL operations are suspended/skipped by the UE. Additionally, if an SCell is activated (e.g., due to a large buffer size in one direction), then the UE may perform both DL and UL operations (regardless of paired or unpaired spectrum and regardless of whether it has data to Rx/Tx on the other direction). However, considering the varied nature of different applications, it may be beneficial to decouple activation/de-activation across DL and UL to achieve higher efficiency. Further, it may be beneficial to activate/de-activate certain operations in each direction based on whether the UE is likely to use the SCell in each direction. Putting a UE in an activated mode for an SCell in both directions may potentially waste power for the UE. For example, if a UE would use an additional bandwidth (BW) in one direction but not the other, the UE still sets its baseband clock frequency (and possibly radio frequency (RF) BW) with the assumption that both DL and UL will be active even though the network may schedule the UE in one direction without scheduling in the other direction. Aspects provided herein may enable a UE to activate/deactivate UL separately from DL for a secondary cell, enabling potentially higher efficiency in the communication and power saving at the UE.

There are several different ways to activate an SCell. A first way may be a direct activation upon RRC configuration of SCells. A second way may be activation/deactivation using a MAC-CE. A third way may be activation via BWP switching (for dormant BWP). A fourth way may be SCell activation/deactivation using a MAC-CE including TRS.

For SCell activation/deactivation via MAC-CE, if the MAC entity is configured with one or more SCells, the network may activate and deactivate the configured SCells. Upon configuration of an SCell, the SCell is deactivated unless the parameter sCellState is set to activated (e.g., if set to activated, the SCell is directly activated upon configuration) for the SCell by upper layers. The configured SCell(s) may activated and deactivated by: (1) receiving the SCell Activation/Deactivation MAC-CE, (2) receiving the Enhanced SCell Activation/Deactivation MAC-CE, (3) configuring the parameter sCellDeactivationTimer timer per configured SCell (except the SCell configured with PUCCH, if any): the associated SCell is deactivated upon its expiry, (4) configuring the parameter sCellState per configured SCell: if configured, the associated SCell is activated upon SCell configuration, (5) receiving the parameter secondary cell group (SCG) state (scg-State): the SCells of SCG are deactivated.

FIG. 4 is a diagram 400 illustrating example MAC-CE for coupled deactivation/activation, in accordance with various aspects of the present disclosure. The SCell Activation/Deactivation MAC-CE of one or more octet is identified by a MAC subheader with logical channel identifier (LCID) and may have a fixed size and consists of a single octet containing a quantity of C-fields and one R-field. The C-field, Cᵢ, may indicate the activation/deactivation status of the SCell with an SCell index represented by IE SCellIndex. The Cᵢ field is set to 1 to indicate that the SCell with SCellIndex i may be activated. The Cᵢ field is set to 0 to indicate that the SCell with SCellIndex i may be deactivated.

The MAC entity may, for each configured SCell, if an SCell is configured with sCellState set to activated upon SCell configuration, or an SCell Activation/Deactivation MAC-CE or an Enhanced SCell Activation/Deactivation MAC-CE is received activating the SCell, if the SCell was deactivated prior to receiving this Enhanced SCell Activation/Deactivation MAC-CE and a TRS is indicated for this SCell, indicate to lower layers the information regarding the TRS. If the SCell was deactivated prior to receiving this SCell Activation/Deactivation MAC-CE or this Enhanced SCell Activation/Deactivation MAC-CE or if the SCell is configured with sCellState set to activated upon SCell configuration, and if firstActiveDownlinkBWP-Id is not set to dormant BWP, the MAC-entity may activate the SCell according to a defined timing for MAC-CE activation and according to a timing defined for direct SCell activation; i.e. apply normal SCell operation including: (1) SRS transmissions on (which may be otherwise referred to as “via”) the SCell, (2) CSI reporting for the SCell, (3) PDCCH monitoring on the SCell, (4) PDCCH monitoring for the SCell, and (5) PUCCH transmissions on the SCell. If the parameter first active downlink BWP ID is set to dormant BWP, the MAC entity may stop the BWP inactivity timer of this Serving Cell, if running. The MAC entity may also activate the DL BWP and UL BWP indicated by first active downlink BWP ID and first active uplink BWP ID respectively and start or restart the SCell deactivation timer associated with the SCell. If the active DL BWP is not the dormant BWP, the MAC entity may (re-) initialize any suspended configured uplink grants of configured grant Type 1 associated with this SCell according to the stored configuration, if any, and to start in the symbol and may trigger power headroom report (PHR).

If an SCell Activation/Deactivation MAC-CE or an Enhanced SCell activation/deactivation MAC-CE is received deactivating the SCell, or if the SCell Deactivation timer associated with the activated SCell expires, or if the SCG associated with the activated SCell is deactivated, the MAC entity may deactivate the SCell, stop the SCell deactivation timer associated with the SCell, stop the BWP inactivity timer associated with the SCell, deactivate any active BWP associated with the SCell, clear any configured downlink assignment and any configured uplink grant Type 2 associated with the SCell respectively, clear any PUSCH resource for semi-persistent CSI reporting associated with the SCell, suspend any configured uplink grant Type 1 associated with the SCell, flush all HARQ buffers associated with the SCell, cancel, if any, triggered consistent listen before talk (LBT) failure for the SCell. If the SCell is deactivated, the UE may not transmit SRS on the SCell, may not report CSI for the SCell, may not transmit on UL-SCH on the SCell, may not transmit on RACH on the SCell, may not monitor the PDCCH on the SCell, may not monitor the PDCCH for the SCell, or may not transmit PUCCH on the SCell. if the SCell is configured as a scheduled cell and with the search space for DCI to schedule multiple cells, the UE may not monitor the PDCCH for scheduling multiple cells for the set of cells.

An SCell can be deactivated using a SCell deactivation timer which may be reset if the PDCCH on the activated SCell indicates an uplink grant or downlink assignment, or if the PDCCH on the Serving Cell scheduling the activated SCell indicates an uplink grant or a downlink assignment for the activated SCell, or if a MAC PDU is transmitted in a configured uplink grant and an LBT failure indication is not received from lower layers, or if a MAC PDU is received in a configured downlink assignment, restart the SCell deactivation timer associated with the SCell.

To reduce the latency of SCell activation, the concept of dormant BWP, which includes PDCCH based activation instead of MAC-CE plus periodic CSI measurement for automatic gain control (AGC), time/frequency tracking (T/F) and beam management. A DL BWP of an SCell can be configured to be a dormant BWP via dedicated RRC signaling. In the dormant BWP, the UE stops monitoring PDCCH on/for the SCell, but continues performing CSI measurements, AGC and beam management, if configured. UL operations that a UE suspends/skips on an SCell whose DL BWP is switched to a dormant BWP. Currently, there is no separate DL/UL dormancy. Once a DL BWP switches to the dormant state, UL activities, such as some UL channels are stopped.

There may be SCell activation/deactivation timelines which depend on one or more of: (1) activation/deactivation scheme (e.g., PDCCH based vs. MAC-CE based), (2) quantity of SCells to be activated simultaneously, (3) SCell is known or unknown, measurement period of the SCell, (4) SCell is contiguous to an active cell in the same band or not, (5) SSB-based RRM measurement timing configuration (SMTC). Using FR1 as an example, an SCell in FR1 is considered known if it has been meeting the following conditions: during the period equal to max (5*measCycleSCell, 5*DRX cycles) for FR1 before the reception of the SCell activation command, the UE has sent a valid measurement report for the SCell being activated. Additionally, the SSB measured remains detectable according to cell identification conditions. Furthermore, the SSB measured during the period equal to max (5*measCycleSCell, 5*DRX cycles) also remains detectable during the SCell activation delay according to the cell identification conditions. Otherwise, the SCell in FR1 is considered unknown.

In some aspects, the activation and deactivation of DL and UL cells may be decoupled (DL and UL activation/deactivation may be separate). For example, separate direct activation may be provided with separate RRC parameters configured for DL and UL, e.g., a parameter sCellState_DL for DL and a parameter sCellState_UL for UL. The configuration of separate parameters for the DL and UL state of the SCell allows the DL operation be set to activated separately from the UL operation. For a MAC-CE based activation/deactivation (e.g., in which the activation/deactivation is indicated in a MAC-CE), separate C_i fields can be included in the MAC-CE for DL and UL per cell, e.g., for a cell C_i (or Cᵢ), the MAC-CE may include a field C_i_DL to activate or deactivate the DL operation of the cell and C_i_UL to activate or deactivate the UL operation of the cell, instead of using a single Cᵢ field that activates or deactivates both DL and UL operation of the cell. For fast activation/deactivation via a dormant BWP (e.g., in which a DCI indicates a BWP switch to the dormant BWP), separate indications for UL and/or DL can be included in the DCI.

When an SCell is activated or de-activated in DL or UL, some types (e.g., which may be defined without signaling or indicated by the activation/deactivation) of DL or UL operations may be started or suspended/skipped, respectively. These operations may be done in the same direction that is activated or may be in the opposite direction (but may be based on the operation in the activated direction, e.g., SRS transmission when DL is activated by UL is not). As an example, if DL is de-activated while UL is activated, all the operations in the DL are stopped/skipped/suspended. Similarly, if UL is deactivated while the DL is activated, all the UL operations may be stopped/skipped/suspended. As another example, if DL is de-activated while UL is activated, some of the operations related to UL may be based on downlink reception by the UE. Similarly, if UL is deactivated while DL is activated, some operations relating to DL operation may be based on UL transmissions from the UE.

As an example, when an SCell is activated in DL and not in UL, it may be indicated for the UE to transmit SRS on the SCell (if configured), but not monitor for UL DCI formats or not transmit PUCCH on the SCell, if configured. Related to PDCCH, when a UE has to monitor PDCCH for one direction without the other, the number of CCEs/BDs may be reduced; the updated values may be defined (e.g., in a wireless standard) and known to the UE without signaling or may be configured for a UE, e.g., via UE-specific or cell-specific signaling. As another example, when an UL SCell (and not DL SCell) is activated, it may be indicated for the UE (e.g., whether defined in the standard or signaled to the UE) to perform certain operations in UL or DL. For example, the UE may transmit UL-SCH, transmit SRS, transmit PUCCH on Scell, report power headroom, and monitor UL DCI formats in DL. The UE may also transmit CG-PUSCH and monitoring UL DCI formats and report power headroom for the cell. If UL is activated but DL is not, PDCCH for UL operations on this cell may be sent on another cell where DL is already activated. Information regarding the another cell may be semi-statically or dynamically indicated to the UE.

The relationship of some operations of the UE to DL or UL activation/deactivation may be defined (e.g., defined in a wireless standard and known to the UE without signaling) and such operations may become active as long as either DL or UL, or both are active for the SCell. For example, PUCCH, if configured on a cell, may become active as long as at least one direction is active (used for HARQ-ACK/CSI if DL is active, and used for SR if UL is active).

As an example, SRS transmission may become active or not upon directional (DL/UL) activation and/or may be a function of use or purpose of a corresponding SRS resource set. For codebook, non-codebook, or beam management purposes, the SRS may become active if the UL direction is activated. For antenna switching purposes, the SRS becomes active if DL is activated. This relationship of the SRS to the activation/deactivation can be either defined in a wireless standard (e.g., known by the UE without signaling) or indicated/signaled to the UE as part of an RRC configuration and/or the activation itself. As an example, the granularity for SRS activation/deactivation may be based on the purpose or intended use of the SRS. When UL is deactivated, the SRS could be transmitted for carrier switching instead of (and not) antenna switching, for example.

If a cell is configured with PUCCH (PCell or PUCCH-SCell), the network may not deactivate UL/PUCCH transmission on this CC (but it is possible for DL direction to be deactivated on this CC), in some aspects. Alternatively, the network may deactivate the UL/PUCCH transmission on the CC under certain conditions, such as the condition that DL direction is deactivated for this cell and all other SCells in the same PUCCH group or for the group of CCs that rely on this cell for PUCCH transmission. In some aspects, DL and UL directions may not be independently activated/deactivated across CCs considering that a PUCCH CC carries the DL feedback (CSI/HARQ-ACK) for other CCs. As another example, when a UE monitors PDCCH on one CC for scheduling DL/UL of other SCells, the DL PDCCH monitoring on the CC may not be de-activated unless all other scheduled cells are de-activated in both directions. In some aspects, the activation and deactivation of the PUCCH SCell could be dependent on the active state of the UL for the SCell. If UL is deactivated for the PUCCH-SCell, a PUCCH group configuration for multiple PUCCH groups (e.g., 2 PUCCH groups) may fall back to a single PUCCH group and vice versa (e.g., multiple PUCCH group configuration may be used based on the activation of UL for the PUCCH SCell). Alternative, another cell with activated UL within the same group may become PUCCH-SCell. The selection of the new PUCCH-SCell may be indicated to the UE dynamically (e.g., via DCI or MAC-CE) or semi-statically (e.g., via UE-specific RRC).

In some aspects, the operations that a UE has to start/stop upon activation/deactivation of an SCell in one direction can be indicated in different ways. In a first example, the operations may be separately defined (e.g., in a wireless standard) based on (tied to or having a relationship to) activation/deactivation of DL or UL. This enables the UE to know to start or stop the defined operation based on the activation/deactivation of DL or UL for a cell and without signaling about which operation(s) to start or stop. For example, a rule may be provided in a wireless standard so that the UE knows that if an SCell is de-activated in DL, the DL HARQ processes may be flushed while UL HARQ processes are kept; a UE may not monitor DL DCI formats while continuing to monitor for UL DCI formats; there may be no transmission of SRS with antenna switching usage; and/or the active DL BWP is not de-activated if a UE may monitor DCI formats applied to UL for the same SCell.

As another example, the base station may signal to the UE operations to start or stop. For example, the activation/deactivation command may include which operations to stop/start. For example, the activation/deactivation command for DL activation/deactivation may indicate or include one or more DL operations to activate/de-activate. Similarly, an UL activation/deactivation may indicate or include one or more UL operations to activate/de-activate. For example, a DL activation/deactivation command may activate/deactivate operations in the DL and not the UL, whereas an UL activation/deactivation command may activate/deactivate operations in the UL and not the DL. In other aspects, the activation/deactivation command in DL may also activate/de-activate operations in UL. Similarly, the activation/deactivation command in UL may also activate/de-activate operations in DL. For example, when activating an SCell in DL, if SRS with active scheduling usage is configured, the UE can be indicated via the same command to start SRS transmission. As another example, when activating an SCell in UL, a UE can be indicated via the same command to start monitoring PDCCH with UL DCI formats. The first and second option may also be combined such that some operations are to be stopped/started upon deactivation/activation of an SCell by default, while some others are indicated via the command.

With MAC-CE based activation/deactivation, the UE may receive an RRC configuration for a given SCell that enables activation of SRS and/or PUCCH transmission. The UE may then receive a MAC-CE with a DL activation command for this SCell. The MAC-CE command may include fields to indicate the deactivation of certain RRC configured operations. For example, the MAC-CE may include fields such as C_i_DL (activating SCell on DL) plus one or multiple of following fields: C_i_SRS and/or C_i_PUCCH. In this example, the MAC-CE may indicate the deactivation of a first operation (e.g., PUCCH operation) separately from the deactivation of a second operation (e.g., SRS operation), for example. In some aspects, when decoupling DL/UL deactivation, the timer-based deactivation may follow separate and independent timers. For timer-based deactivation, separate timers for DL and UL may be configured per cell, e.g., separate SCell deactivation timer for DL and SCell deactivation timer for UL. In some aspects, the timers may be restarted independent and/or may be triggered by different DL and UL operations. For example, the DL timer may be restarted if PDCCH on the SCell or for the SCell provides a DL grant or if a MAC PDU is received for DL configured assignment. The UL timer may be restarted if PDCCH on the SCell or for the SCell provides an UL grant or if a MAC PDU is transmitted in an UL configured grant and LBT failure indication is not received from the lower layers.

In some aspects, decoupled DL/UL activation/deactivation features may be applied to all SCells under one MAC entity (e.g., to the SCells in one cell group), to SCells in one PUCCH group, to SCells within one TAG, to SCells in a particular band/FR, or may be applied separately and independently per SCell. In some aspects, when applied to a group of SCells, associated restrictions or relationships (of operations) may be defined (e.g., in a wireless standard) and enforced or applied without additional signaling or may be indicated by the network (e.g., via UE specific RRC signaling). If not applied to all SCells, then it is possible to have some SCells for which DL/UL activation/deactivation is coupled (UL and DL are activated or deactivated together) and another subset of SCells, for which DL/UL activation/deactivation is de-coupled (UL is activated/deactivated separately from DL). In some aspects, the UE may report support for decoupled DL/UL cell activation/deactivation as a UE capability. The support may further be dependent on the scheme for cell activation/deactivation (e.g., direct activation, MAC-CE based indication, or BWP switching with dormancy). The support of the feature may be applicable to a particular frequency range, such as certain bands/FRs, band combinations, or bands within a band combination. The capability may also include the quantity of CCs for which the UE can support the decoupled SCell activation or deactivation.

In some aspects, based on decoupling the DL and UL SCell activation/deactivation, timeline specification may also be separately defined. In some aspects, under decoupled DL/UL SCell activation/deactivation, the timelines for DL or UL cell activation or deactivation may be separate (e.g., different or independent). For example, the DL SCell activation may be dependent on the SSB configuration on the same cell (or another cell), while for UL SCell activation, the timelines could be dependent on the SSB configuration (e.g, or any other reference signal that may be used for performing measurements targeted for SCell activation) on a cell from which SSB measurements may be applied to UL of the intended cell. The reference signals used for DL activation and UL activation may be different, e.g., different types of reference signals or that they are present on different carriers. Further, the timelines could be dependent on which operations on the same direction or opposite direction need to be activated/de-activated. In some aspects, when activating multiple cells simultaneously, where some cell(s) are activated in DL, some cell(s) in UL and some cell(s) in both directions, the timelines may be dependent on the number of cells in each group separately (since DL activation/deactivation, UL activation/deactivation and joint activation/deactivation may have different latency). In some aspects, uplink deactivation can also be applied to SUL via dynamic signaling (MAC-CE or DCI). In particular, when a UE is in good UL coverage, the network may deactivate the supplementary uplink (SUL) and keep another type of UL. When a UE is going away from the cell, the network can activate SUL again.

FIG. 5 is a diagram 500 illustrating example communications between a network entity 504 and a UE 502, in accordance with various aspects of the present disclosure. As illustrated in FIG. 5, the UE 502 may transmit a capability indication 506 that indicates support for separate (e.g., decoupled) DL/UL cell activation/deactivation to the network entity 504. The network entity 504 may transmit at least one (e.g., 510) of a DL activation 510C, a DL deactivation 510D, an UL activation 510A, or an UL deactivation 510B for a secondary cell, the DL activation, the DL deactivation, the UL activation, or the UL deactivation being separate from each other. Based on the received UL/DL activation/deactivation, the UE 502 may stop/suspend/skip some operations at 512, as previously described. The UE 502 may also transmit at least one UL transmission via the SCell at 514 and receive at least one DL transmission via the SCell at 516.

FIG. 6 is a diagram 600 illustrating example communications between a network entity and a UE, in accordance with various aspects of the present disclosure. As illustrated in FIG. 6, the UE 602 may transmit a capability indication 606 that indicates support for separate (e.g., decoupled) DL/UL cell activation/deactivation to the network entity 604. The network entity 604 may transmit a DL deactivation 610D and an UL activation 610A for a secondary cell. Based on the DL deactivation 610D and the UL activation 610A, the UE 602 may stop/suspend/skip PDSCH at 612. The UE 602 may also transmit at least one UL transmission via the SCell at 614 and receive at least one DCI for the at least one UL transmission via the SCell at 616.

FIG. 7 is a diagram 700 illustrating example communications between a network entity and a UE, in accordance with various aspects of the present disclosure. As illustrated in FIG. 7, the UE 702 may transmit a capability indication 706 that indicates support for separate (e.g., decoupled) DL/UL cell activation/deactivation to the network entity 704. The network entity 704 may transmit an UL deactivation 710B and a DL activation 710C for a secondary cell. Based on the UL deactivation 710B and the DL activation 710C, the UE 702 may stop/suspend/skip PUSCH at 712. The UE 702 may also receive at least one DL transmission via the SCell at 716 and transmit PUCCH/SRS at 718.

FIG. 8 is a flowchart 800 of a method of wireless communication. The method may be performed by a UE (e.g., the UE 104, the UE 350, the UE 502, the UE 602, the UE 702; the apparatus 1004). The method may enable a UE to separately activate/deactivate UL/DL for a secondary cell, enabling potentially higher efficiency in the communication and power saving at the UE.

At 802, the UE may receive, from a network entity, at least one of a DL activation, a DL deactivation, an UL activation, or an UL deactivation for a secondary cell, the DL activation, the DL deactivation, the UL activation, or the UL deactivation being separate from each other. For example, the UE 502 may receive, from a network entity, at least one of a DL activation (e.g., 510C), a DL deactivation (e.g., 510D), an UL activation (e.g., 510A), or an UL deactivation (e.g., 510B) for a secondary cell, the DL activation, the DL deactivation, the UL activation, or the UL deactivation being separate from each other. In some aspects, 802 may be performed by activation/deactivation component 198.

At 804, the UE may communicate with the secondary cell based on the DL activation, the DL deactivation, the UL activation, or the UL deactivation. For example, the UE 502 may communicate (e.g., 514 or 516) with the secondary cell based on the DL activation, the DL deactivation, the UL activation, or the UL deactivation. In some aspects, 804 may be performed by activation/deactivation component 198.

FIG. 9 is a flowchart 900 of a method of wireless communication. The method may be performed by a UE (e.g., the UE 104, the UE 350, the UE 502, the UE 602, the UE 702; the apparatus 1004). The method may enable a UE to separately activate/deactivate UL/DL for a secondary cell, enabling potentially higher efficiency in the communication and power saving at the UE.

At 902, the UE may receive, from a network entity, at least one of a DL activation, a DL deactivation, an UL activation, or an UL deactivation for a secondary cell, the DL activation, the DL deactivation, the UL activation, or the UL deactivation being separate from each other. For example, the UE 502 may receive, from a network entity, at least one of a DL activation (e.g., 510C), a DL deactivation (e.g., 510D), an UL activation (e.g., 510A), or an UL deactivation (e.g., 510B) for a secondary cell, the DL activation, the DL deactivation, the UL activation, or the UL deactivation being separate from each other. In some aspects, 902 may be performed by activation/deactivation component 198. In some aspects, each of the DL activation, the DL deactivation, the UL activation, or the UL deactivation may be associated with one or more specific types of UL or DL operation to be activated or deactivated, such as at least one combination of deactivation or activation of PDSCH, PUSCH, PUCCH of various types (e.g., based on whether the PUCCH supports DL or UL data transmission), PDCCH of various types, SRS, or the like.

At 904, the UE may communicate with the secondary cell based on the DL activation, the DL deactivation, the UL activation, or the UL deactivation. For example, the UE 502 may communicate (e.g., 514 or 516) with the secondary cell based on the DL activation, the DL deactivation, the UL activation, or the UL deactivation. In some aspects, 904 may be performed by activation/deactivation component 198.

In some aspects, the at least one of the DL activation, the DL deactivation, the UL activation, or the UL deactivation is the DL activation or the UL deactivation for the secondary cell. At 910, the UE may receive at least one DL transmission via the secondary cell. For example, the UE 702 may receive at least one DL transmission (e.g., 716) via the secondary cell. In some aspects, 910 may be performed by activation/deactivation component 198. At 912, the UE may stop/suspend/skip at least one UL transmission via the secondary cell. For example, the UE 702 may stop/suspend/skip (e.g., at 712) at least one UL transmission via the secondary cell. In some aspects, 912 may be performed by activation/deactivation component 198. In some aspects, the at least one DL transmission includes at least one PDSCH transmission via the secondary cell, and where the at least one UL transmission includes at least one PUSCH transmission via the secondary cell. In some aspects, the at least one UL transmission includes at least one PUCCH transmission via the secondary cell. At 914, the UE may transmit at least one SRS transmission via the secondary cell and transmit at least one physical uplink control channel (PUCCH) transmission that carries hybrid automatic repeat request (HARQ), scheduling request (SR), or channel state information (CSI) via the secondary cell. For example, the UE 602 may transmit at least one SRS transmission via the secondary cell and transmit at least one physical uplink control channel (PUCCH) transmission (e.g., 714) that carries hybrid automatic repeat request (HARQ), scheduling request (SR), or channel state information (CSI) via the secondary cell. In some aspects, 914 may be performed by activation/deactivation component 198.

In some aspects, the at least one DL transmission or the at least one UL transmission is specified by the DL activation or the UL deactivation or defined separately from the DL activation or the UL deactivation.

In some aspects, the at least one of the DL activation, the DL deactivation, the UL activation, or the UL deactivation is the UL activation or the DL deactivation for the secondary cell. At 920, the UE may stop/suspend/skip (e.g., 612) at least one DL transmission via the secondary cell. For example, the UE 602 may stop/suspend/skip at least one DL transmission via the secondary cell. In some aspects, 920 may be performed by activation/deactivation component 198. At 922, the UE may transmit at least one UL transmission via the secondary cell. For example, the UE 602 may transmit at least one UL transmission via the secondary cell. In some aspects, 922 may be performed by activation/deactivation component 198. In some aspects, the at least one DL transmission includes at least one physical downlink shared channel (PDSCH) transmission via the secondary cell, and where the at least one UL transmission includes at least one physical uplink shared channel (PUSCH) transmission via the secondary cell.

At 924, the UE may receive downlink control information (DCI) associated with the at least one UL transmission via the secondary cell. For example, the UE 602 may receive downlink control information (DCI) (e.g., 616) associated with the at least one UL transmission via the secondary cell. In some aspects, 924 may be performed by activation/deactivation component 198.

In some aspects, the at least one DL transmission or the at least one UL transmission is specified by the UL activation or the DL deactivation or defined separately from the UL activation or the DL deactivation.

In some aspects, the DL activation, the DL deactivation, the UL activation, or the UL deactivation occupy a standalone field (e.g., C_i_DL or C_i_UL) in a medium access control (MAC) control element (MAC-CE).

In some aspects, the UE may receive a first deactivation timer associated with the DL deactivation and a second deactivation timer associated with the UL deactivation. In some aspects, the at least one of the DL activation, the DL deactivation, the UL activation, or the UL deactivation is associated with a medium access control (MAC) entity associated with a first set of cells including the secondary cell, a timing advance group (TAG) associated with a second set of cells including the secondary cell, a frequency range associated with a third set of cells including the secondary cell, or associated with the secondary cell independently.

In some aspects, at 901, the UE may transmit, to the network entity, a capability indication (e.g., 506, 606, 706) indicating support for separation of the DL activation, the DL deactivation, the UL activation, or the UL deactivation. In some aspects, the support for the separation of the DL activation, the DL deactivation, the UL activation, or the UL deactivation is associated with a frequency range.

In some aspects, a first timeline is associated with the DL deactivation or the DL activation, and where a second timeline is associated with the UL deactivation or the UL activation. In some aspects, the uplink deactivation is associated with supplementary uplink based on dynamic signaling.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor 1024 (also referred to as a modem) coupled to one or more transceivers 1022 (e.g., cellular RF transceiver). The cellular baseband processor(s) 1024 may include at least one on-chip memory 1024′. In some aspects, the apparatus 1004 may further include one or more subscriber identity modules (SIM) cards 1020 and at least one application processor 1006 coupled to a secure digital (SD) card 1008 and a screen 1010. The application processor(s) 1006 may include on-chip memory 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) 1024 communicates through the transceiver(s) 1022 via one or more antennas 1080 with the UE 104 and/or with an RU associated with a network entity 1002. The cellular baseband processor(s) 1024 and the application processor(s) 1006 may each include a computer-readable medium/memory 1024′, 1006′, respectively. The additional memory modules 1026 may also be considered a computer-readable medium/memory. Each computer-readable medium/memory 1024′, 1006′, 1026 may be non-transitory. The cellular baseband processor(s) 1024 and the application processor(s) 1006 are each responsible for general processing, including the execution of software stored on the computer-readable medium/memory. The software, when executed by the cellular baseband processor(s) 1024/application processor(s) 1006, causes the cellular baseband processor(s) 1024/application processor(s) 1006 to perform the various functions described supra. The computer-readable medium/memory may also be used for storing data that is manipulated by the cellular baseband processor(s) 1024/application processor(s) 1006 when executing software. The cellular baseband processor(s) 1024/application processor(s) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) 1024 and/or the application processor(s) 1006, and in another configuration, the apparatus 1004 may be the entire UE (e.g., see UE 350 of FIG. 3) and include the additional modules of the apparatus 1004.

As discussed supra, the activation/deactivation component 198 may be configured to receive, from a network entity, at least one of a downlink (DL) activation, a DL deactivation, a uplink (UL) activation, or an UL deactivation for a secondary cell, the DL activation, the DL deactivation, the UL activation, or the UL deactivation being separate from each other. In some aspects, the activation/deactivation component 198 may be further configured to communicate with the secondary cell based on the DL activation, the DL deactivation, the UL activation, or the UL deactivation. The activation/deactivation component 198 and/or the apparatus 1004 may be further configured to perform any of the aspects described in connection with the flowchart in FIGS. 8 and/or 9 or performed by the UE in any of FIGS. 5-7. The activation/deactivation component 198 may be within the cellular baseband processor(s) 1024, the application processor(s) 1006, or both the cellular baseband processor(s) 1024 and the application processor(s) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) 1024 and/or the application processor(s) 1006, may include means for receiving, from a network entity, one of a downlink (DL) activation, a DL deactivation, a uplink (UL) activation, or an UL deactivation for a secondary cell, the DL activation, the DL deactivation, the UL activation, or the UL deactivation being separate from each other. In some aspects, the apparatus 1004 may include means for communicating with the secondary cell based on the DL activation, the DL deactivation, the UL activation, or the UL deactivation. In some aspects, the apparatus 1004 may include means for receiving at least one DL transmission via the secondary cell. In some aspects, the apparatus 1004 may include means for skipping at least one UL transmission via the secondary cell. In some aspects, the apparatus 1004 may include means for transmitting at least one sounding reference signal (SRS) transmission via the secondary cell. In some aspects, the apparatus 1004 may include means for transmitting at least one physical uplink control channel (PUCCH) transmission that carries hybrid automatic repeat request (HARQ), scheduling request (SR), or channel state information (CSI) via the secondary cell. In some aspects, the apparatus 1004 may include means for skipping at least one DL transmission via the secondary cell. In some aspects, the apparatus 1004 may include means for transmitting at least one UL transmission via the secondary cell. In some aspects, the apparatus 1004 may include means for receiving downlink control information (DCI) associated with the at least one UL transmission via the secondary cell. In some aspects, the apparatus 1004 may include means for receiving a first deactivation timer associated with the DL deactivation and a second deactivation timer associated with the UL deactivation. In some aspects, the apparatus 1004 may include means for transmitting, to the network entity, a capability indication indicating support for separation of the DL activation, the DL deactivation, the UL activation, or the UL deactivation. The apparatus 1004 may further include means for performing any of the aspects described in connection with the flowchart in FIGS. 8 and/or 9 or performed by the UE in any of FIGS. 5-7. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 11 is a flowchart 1100 of a method of wireless communication. The method may be performed by a network node or network entity such as a base station or one or more components of a base station (e.g., the base station 102, 310; CU 110; D 130; RU 140; network entity 504, 604, 704, 1302). The method may enable a network entity to separately activate/deactivate UL/DL for a secondary cell, enabling potentially higher efficiency in the communication and power saving for UEs and/or network entity.

At 1102, the network entity, may transmit at least one of a DL activation, a DL deactivation, an UL activation, or an UL deactivation for a secondary cell, the DL activation, the DL deactivation, the UL activation, or the UL deactivation being separate from each other. For example, the network entity 504 shows and example of transmitting at least one of a DL activation (e.g., 510C), a DL deactivation (e.g., 510D), an UL activation (e.g., 510A), or an UL deactivation (e.g., 510B) for a secondary cell, the DL activation, the DL deactivation, the UL activation, or the UL deactivation being separate from each other. In some aspects, 1102 may be performed by activation/deactivation component 199.

At 1104, the network entity may communicate with a UE via the secondary cell based on the DL activation, the DL deactivation, the UL activation, or the UL deactivation. For example, the network entity 504 is shown communicating with the UE 502 (e.g., 514 or 516) with the secondary cell based on the DL activation, the DL deactivation, the UL activation, or the UL deactivation. In some aspects, 1104 may be performed by activation/deactivation component 199.

FIG. 12 is a flowchart 1200 of a method of wireless communication. The method may be performed by a network node or network entity such as a base station or one or more components of a base station (e.g., the base station 102, 310; CU 110; D 130; RU 140; network entity 504, 604, 704, 1302). The method may enable a network entity to separately activate/deactivate UL/DL for a secondary cell, enabling potentially higher efficiency in the communication and power saving for UEs and/or network entity.

At 1202, the network entity, may transmit at least one of a DL activation, a DL deactivation, an UL activation, or an UL deactivation for a secondary cell, the DL activation, the DL deactivation, the UL activation, or the UL deactivation being separate from each other. For example, the network entity 504 shows and example of transmitting at least one of a DL activation (e.g., 510C), a DL deactivation (e.g., 510D), an UL activation (e.g., 510A), or an UL deactivation (e.g., 510B) for a secondary cell, the DL activation, the DL deactivation, the UL activation, or the UL deactivation being separate from each other. In some aspects, 1102 may be performed by activation/deactivation component 199.

In some aspects, each of the DL activation, the DL deactivation, the UL activation, or the UL deactivation may be associated with one or more specific types of UL or DL operation to be activated or deactivated, such as at least one combination of deactivation or activation of PDSCH, PUSCH, PUCCH of various types (e.g., based on whether the PUCCH supports DL or UL data transmission), PDCCH of various types, SRS, or the like.

At 1204, the network entity may communicate with a UE via the secondary cell based on the DL activation, the DL deactivation, the UL activation, or the UL deactivation. For example, the network entity 504 is shown communicating with the UE 502 (e.g., 514 or 516) with the secondary cell based on the DL activation, the DL deactivation, the UL activation, or the UL deactivation. In some aspects, 1104 may be performed by activation/deactivation component 199.

In some aspects, the at least one of the DL activation, the DL deactivation, the UL activation, or the UL deactivation is the DL activation or the UL deactivation for the secondary cell. At 1210, the network entity may transmit at least one DL transmission via the secondary cell. For example, the network entity 704 may transmit at least one DL transmission (e.g., 716) via the secondary cell. In some aspects, 1210 may be performed by activation/deactivation component 199. At 1212, the network entity may skip reception of (or may not expect to receive) at least one UL transmission via the secondary cell. For example, the network entity 704 may stop (e.g., at 712) reception of at least one UL transmission via the secondary cell. In some aspects, 1212 may be performed by activation/deactivation component 199. In some aspects, the at least one DL transmission includes at least one PDSCH transmission via the secondary cell, and where the at least one UL transmission includes at least one PUSCH transmission via the secondary cell. In some aspects, the at least one UL transmission includes at least one PUCCH transmission via the secondary cell. At 1214, the network entity may receive at least one SRS transmission via the secondary cell and receive at least one physical uplink control channel (PUCCH) transmission that carries hybrid automatic repeat request (HARQ), scheduling request (SR), or channel state information (CSI) via the secondary cell. For example, the network entity 604 may receive at least one SRS transmission via the secondary cell and receive at least one physical uplink control channel (PUCCH) transmission (e.g., 714) that carries hybrid automatic repeat request (HARQ), scheduling request (SR), or channel state information (CSI) via the secondary cell. In some aspects, 1214 may be performed by activation/deactivation component 199.

In some aspects, the at least one DL transmission or the at least one UL transmission is indicated by the DL activation or the UL deactivation or defined separately from the DL activation or the UL deactivation.

In some aspects, the at least one of the DL activation, the DL deactivation, the UL activation, or the UL deactivation is the UL activation or the DL deactivation for the secondary cell. At 1220, the network entity may skip (e.g., 612) at least one DL transmission via the secondary cell. For example, the network entity 604 may skip at least one DL transmission via the secondary cell. In some aspects, 1220 may be performed by activation/deactivation component 199. At 1222, the network entity may receive at least one UL transmission via the secondary cell. For example, the UE 602 may transmit at least one UL transmission via the secondary cell, which the network entity 604 may receive. In some aspects, 1222 may be performed by activation/deactivation component 199. In some aspects, the at least one DL transmission includes at least one physical downlink shared channel (PDSCH) transmission via the secondary cell, and where the at least one UL transmission includes at least one physical uplink shared channel (PUSCH) transmission via the secondary cell.

At 1224, the network entity may transmit downlink control information (DCI) associated with the at least one UL transmission via the secondary cell. For example, the network entity 604 may transmit downlink control information (DCI) (e.g., 616) associated with the at least one UL transmission via the secondary cell. In some aspects, 1224 may be performed by activation/deactivation component 199.

In some aspects, the at least one DL transmission or the at least one UL transmission is indicated by the UL activation or the DL deactivation or defined separately from the UL activation or the DL deactivation.

In some aspects, the DL activation, the DL deactivation, the UL activation, or the UL deactivation occupy a standalone field (e.g., C_i_DL or C_i_UL) in a medium access control (MAC) control element (MAC-CE), e.g., the MAC-CE may include separate fields for the DL activation, the DL deactivation, the UL activation, and the UL deactivation.

In some aspects, the network entity may transmit a first deactivation timer associated with the DL deactivation and a second deactivation timer associated with the UL deactivation. In some aspects, the at least one of the DL activation, the DL deactivation, the UL activation, or the UL deactivation is associated with a medium access control (MAC) entity associated with a first set of cells including the secondary cell, a timing advance group (TAG) associated with a second set of cells including the secondary cell, a frequency range associated with a third set of cells including the secondary cell, or associated with the secondary cell independently.

In some aspects, at 1201, the network entity may receive a capability indication (e.g., 506, 606, 706) indicating support for separation of the DL activation, the DL deactivation, the UL activation, or the UL deactivation. In some aspects, the support for the separation of the DL activation, the DL deactivation, the UL activation, or the UL deactivation is associated with a frequency range.

In some aspects, a first timeline is associated with the DL deactivation or the DL activation, and where a second timeline is associated with the UL deactivation or the UL activation. In some aspects, the uplink deactivation is associated with supplementary uplink based on dynamic signaling.

FIG. 13 is a diagram 1300 illustrating an example of a hardware implementation for a network entity 1302. The network entity 1302 may be a BS, a component of a BS, or may implement BS functionality. The network entity 1302 may include at least one of a CU 1310, a DU 1330, or an RU 1340. For example, depending on the layer functionality handled by the component 199, the network entity 1302 may include the CU 1310; both the CU 1310 and the DU 1330; each of the CU 1310, the DU 1330, and the RU 1340; the DU 1330; both the DU 1330 and the RU 1340; or the RU 1340. The CU 1310 may include at least one CU processor 1312. The CU processor(s) 1312 may include on-chip memory 1312′. In some aspects, the CU 1310 may further include additional memory modules 1314 and a communications interface 1318. The CU 1310 communicates with the DU 1330 through a midhaul link, such as an F1 interface. The DU 1330 may include at least one DU processor 1332. The DU processor(s) 1332 may include on-chip memory 1332′. In some aspects, the DU 1330 may further include additional memory modules 1334 and a communications interface 1338. The DU 1330 communicates with the RU 1340 through a fronthaul link. The RU 1340 may include at least one RU processor 1342. The RU processor(s) 1342 may include on-chip memory 1342′. In some aspects, the RU 1340 may further include additional memory modules 1344, one or more transceivers 1346, antennas 1380, and a communications interface 1348. The RU 1340 communicates with the UE 104. The on-chip memory 1312′, 1332′, 1342′ and the additional memory modules 1314, 1334, 1344 may each be considered a computer-readable medium/memory. Each computer-readable medium/memory may be non-transitory. Each of the processors 1312, 1332, 1342 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit at least one of a downlink (DL) activation, a DL deactivation, a uplink (UL) activation, or an UL deactivation for a secondary cell, the DL activation, the DL deactivation, the UL activation, or the UL deactivation being separate from each other. In some aspects, the activation/deactivation component 199 may be further configured to communicate with a UE via the secondary cell based on the DL activation, the DL deactivation, the UL activation, or the UL deactivation. The activation/deactivation component 199 and/or the network entity 1302 may be further configured to perform any of the aspects described in connection with the flowchart in FIGS. 11 and/or 12 or performed by the network entity in any of FIGS. 5-7. The component 199 may be within one or more processors of one or more of the CU 1310, DU 1330, and the RU 1340. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1302 may include a variety of components configured for various functions. In one configuration, the network entity 1302 may include means for transmitting one of a downlink (DL) activation, a DL deactivation, a uplink (UL) activation, or an UL deactivation for a secondary cell, the DL activation, the DL deactivation, the UL activation, or the UL deactivation being separate from each other; and means for communicating with a UE via the secondary cell based on the DL activation, the DL deactivation, the UL activation, or the UL deactivation. In some aspects, the network entity 1302 may include means for transmitting at least one DL transmission via the secondary cell. In some aspects, the network entity 1302 may include means for skipping reception of at least one UL transmission via the secondary cell. In some aspects, the network entity 1302 may include means for receiving at least one sounding reference signal (SRS) transmission via the secondary cell. In some aspects, the network entity 1302 may include means for receiving at least one physical uplink control channel (PUCCH) transmission that carries hybrid automatic repeat request (HARQ), scheduling request (SR), or channel state information (CSI) via the secondary cell. In some aspects, the network entity 1302 may include means for skipping at least one DL transmission via the secondary cell. In some aspects, the network entity 1302 may include means for receiving at least one UL transmission via the secondary cell. In some aspects, the network entity 1302 may include means for transmitting downlink control information (DCI) associated with the at least one UL transmission via the secondary cell. In some aspects, the network entity 1302 may include means for transmitting a first deactivation timer associated with the DL deactivation and a second deactivation timer associated with the UL deactivation. In some aspects, the network entity 1302 may include means for receiving a capability indication indicating support for separation of the DL activation, the DL deactivation, the UL activation, or the UL deactivation. The network entity 1302 may further include means for performing any of the aspects described in connection with the flowchart in FIGS. 11 and/or 12 or performed by the network entity in any of FIGS. 5-7. The means may be the component 199 of the network entity 1302 configured to perform the functions recited by the means. As described supra, the network entity 1302 may include the TX processor 316, the RX processor 370, and the controller/processor 375. As such, in one configuration, the means may be the TX processor 316, the RX processor 370, and/or the controller/processor 375 configured to perform the functions recited by the means.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S⊆F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” or “based on or otherwise in association with” unless specifically recited differently. As used herein, the phrase “associated with” encompasses any association, relation, or connection link. Among other examples, the phrase “associated with” may include in association with, based on, based at least in part on, corresponding to, related to, in response to, linked with, and/or connected with. As used herein, “using” may include any use, which may include any consideration, any calculation, and/or any dependency, among examples of use.

The following aspects are illustrative only and may be combined with other aspects or teachings described herein, without limitation.

Aspect 1 is an apparatus for wireless communication at a user equipment (UE), including: at least one memory; and at least one processor coupled to the at least one memory, based at least in part on information stored in the at least one memory, the at least one processor is configured to cause the UE to: receive, from a network entity, at least one of a downlink (DL) activation, a DL deactivation, a uplink (UL) activation, or an UL deactivation for a secondary cell, where the DL activation, the DL deactivation, the UL activation, or the UL deactivation are separate from each other; and communicate with the secondary cell based on the DL activation, the DL deactivation, the UL activation, or the UL deactivation.

Aspect 2 is the apparatus of aspect 1, where the at least one of the DL activation, the DL deactivation, the UL activation, or the UL deactivation is the DL activation or the UL deactivation for the secondary cell, and where the at least one processor is further configured to cause the UE to: receive at least one DL transmission via the secondary cell based on the DL activation; and skip at least one UL transmission via the secondary cell based on the UL deactivation.

Aspect 3 is the apparatus of aspect 2, where the at least one DL transmission includes at least one physical downlink shared channel (PDSCH) transmission via the secondary cell, and where the at least one UL transmission includes at least one physical uplink shared channel (PUSCH) transmission via the secondary cell.

Aspect 4 is the apparatus of aspect 3, where the at least one UL transmission includes at least one physical uplink control channel (PUCCH) transmission via the secondary cell, and where the at least one processor is further configured to cause the UE to: transmit at least one sounding reference signal (SRS) transmission via the secondary cell.

Aspect 5 is the apparatus of aspect 4, where following reception of the UL deactivation, the at least one SRS transmission is associated with a carrier switching and not antenna switching.

Aspect 6 is the apparatus of any of aspects 3-5, where the at least one processor is further configured to cause the UE to: transmit at least one physical uplink control channel (PUCCH) transmission that carries hybrid automatic repeat request (HARQ), scheduling request (SR), or channel state information (CSI) via the secondary cell.

Aspect 7 is the apparatus of any of aspects 2-6, where the at least one DL transmission or the at least one UL transmission is indicated by the DL activation or the UL deactivation or indicated separately from the DL activation or the UL deactivation.

Aspect 8 is the apparatus of any of aspects 1-7, where the at least one of the DL activation, the DL deactivation, the UL activation, or the UL deactivation is the UL activation or the DL deactivation for the secondary cell, and where the at least one processor is further configured to cause the UE to: skip reception of at least one DL transmission via the secondary cell based on the DL deactivation; and transmit at least one UL transmission via the secondary cell based on the UL activation.

Aspect 9 is the apparatus of aspect 8, where the at least one DL transmission includes at least one physical downlink shared channel (PDSCH) transmission via the secondary cell, and where the at least one UL transmission includes at least one physical uplink shared channel (PUSCH) transmission via the secondary cell.

Aspect 10 is the apparatus of any of aspects 8-9, where the at least one processor is further configured to cause the UE to: receive downlink control information (DCI) associated with the at least one UL transmission via the secondary cell.

Aspect 11 is the apparatus of any of aspects 8-10, where the at least one DL transmission or the at least one UL transmission is indicated by the UL activation or the DL deactivation or indicated separately from the UL activation or the DL deactivation.

Aspect 12 is the apparatus of any of aspects 1-11, where the DL activation, the DL deactivation, the UL activation, or the UL deactivation are received in a medium access control (MAC) control element (MAC-CE) that includes separate fields for the DL activation, the DL deactivation, the UL activation, and the UL deactivation.

Aspect 13 is the apparatus of any of aspects 1-12, where the at least one processor is further configured to cause the UE to: receive a first deactivation timer associated with the DL deactivation and a second deactivation timer associated with the UL deactivation.

Aspect 14 is the apparatus of any of aspects 1-13, where the at least one of the DL activation, the DL deactivation, the UL activation, or the UL deactivation is associated with a medium access control (MAC) entity associated with a first set of cells including the secondary cell, a timing advance group (TAG) associated with a second set of cells including the secondary cell, a frequency range associated with a third set of cells including the secondary cell, or associated with the secondary cell independently.

Aspect 15 is the apparatus of any of aspects 1-14, where the at least one processor is further configured to cause the UE to: transmit, to the network entity, a capability indication indicating support for separation of the DL activation, the DL deactivation, the UL activation, or the UL deactivation.

Aspect 16 is the apparatus of aspect 15, where the support for the separation of the DL activation, the DL deactivation, the UL activation, or the UL deactivation is associated with a frequency range.

Aspect 17 is the apparatus of any of aspects 1-16, where a first timeline is associated with the DL deactivation or the DL activation, and where a second timeline is associated with the UL deactivation or the UL activation.

Aspect 18 is the apparatus of any of aspects 1-17, where the uplink deactivation is associated with supplementary uplink based on dynamic signaling.

Aspect 19 is an apparatus for wireless communication at a network entity, including: at least one memory; and at least one processor coupled to the at least one memory, based at least in part on information stored in the at least one memory, the at least one processor is configured to cause the network entity to: transmit at least one of a downlink (DL) activation, a DL deactivation, a uplink (UL) activation, or an UL deactivation for a secondary cell, the DL activation, the DL deactivation, the UL activation, or the UL deactivation being separate from each other; and communicate with a user equipment (UE) via the secondary cell based on the DL activation, the DL deactivation, the UL activation, or the UL deactivation.

Aspect 20 is a method of wireless communication for implementing any of aspects 1 to 19.

Aspect 21 is a computer-readable medium (e.g., a non-transitory computer-readable medium) storing computer executable code, the code when executed by at least one processor causes the at least one processor to implement any of aspects 1 to 19.

Aspect 22 is an apparatus comprising means for implementing any of aspects 1 to 19.

What is claimed is:

1. An apparatus for wireless communication at a user equipment (UE), comprising:
at least one memory; and
at least one processor coupled to the at least one memory, based at least in part on information stored in the at least one memory, the at least one processor is configured to cause the UE to:
receive, from a network entity, at least one of a downlink (DL) activation, a DL deactivation, a uplink (UL) activation, or an UL deactivation for a secondary cell, wherein the DL activation, the DL deactivation, the UL activation, or the UL deactivation are separate from each other; and
communicate with the secondary cell based on the DL activation, the DL deactivation, the UL activation, or the UL deactivation.

2. The apparatus of claim 1, wherein the at least one of the DL activation, the DL deactivation, the UL activation, or the UL deactivation is the DL activation or the UL deactivation for the secondary cell, and wherein the at least one processor is further configured to cause the UE to:
receive at least one DL transmission via the secondary cell based on the DL activation; and
skip at least one UL transmission via the secondary cell based on the UL deactivation.

3. The apparatus of claim 2, wherein the at least one DL transmission comprises at least one physical downlink shared channel (PDSCH) transmission via the secondary cell, and wherein the at least one UL transmission comprises at least one physical uplink shared channel (PUSCH) transmission via the secondary cell.

4. The apparatus of claim 3, wherein the at least one UL transmission comprises at least one physical uplink control channel (PUCCH) transmission via the secondary cell, and wherein the at least one processor is further configured to cause the UE to:
transmit at least one sounding reference signal (SRS) transmission via the secondary cell.

5. The apparatus of claim 4, wherein following reception of the UL deactivation, the at least one SRS transmission is associated with a carrier switching and not antenna switching.

6. The apparatus of claim 3, wherein the at least one processor is further configured to cause the UE to:
transmit at least one physical uplink control channel (PUCCH) transmission that carries hybrid automatic repeat request (HARQ), scheduling request (SR), or channel state information (CSI) via the secondary cell.

7. The apparatus of claim 2, wherein the at least one DL transmission or the at least one UL transmission is indicated by the DL activation or the UL deactivation or indicated separately from the DL activation or the UL deactivation.

8. The apparatus of claim 1, wherein the at least one of the DL activation, the DL deactivation, the UL activation, or the UL deactivation is the UL activation or the DL deactivation for the secondary cell, and wherein the at least one processor is further configured to cause the UE to:
skip reception of at least one DL transmission via the secondary cell based on the DL deactivation; and
transmit at least one UL transmission via the secondary cell based on the UL activation.

9. The apparatus of claim 8, wherein the at least one DL transmission comprises at least one physical downlink shared channel (PDSCH) transmission via the secondary cell, and wherein the at least one UL transmission comprises at least one physical uplink shared channel (PUSCH) transmission via the secondary cell.

10. The apparatus of claim 8, wherein the at least one processor is further configured to cause the UE to:
receive downlink control information (DCI) associated with the at least one UL transmission via the secondary cell.

11. The apparatus of claim 8, wherein the at least one DL transmission or the at least one UL transmission is indicated by the UL activation or the DL deactivation or indicated separately from the UL activation or the DL deactivation.

12. The apparatus of claim 1, wherein the DL activation, the DL deactivation, the UL activation, or the UL deactivation are received in a medium access control (MAC) control element (MAC-CE) that includes separate fields for the DL activation, the DL deactivation, the UL activation, and the UL deactivation.

13. The apparatus of claim 1, wherein the at least one processor is further configured to cause the UE to:
receive a first deactivation timer associated with the DL deactivation and a second deactivation timer associated with the UL deactivation.

14. The apparatus of claim 1, wherein the at least one of the DL activation, the DL deactivation, the UL activation, or the UL deactivation is associated with a medium access control (MAC) entity associated with a first set of cells including the secondary cell, a timing advance group (TAG) associated with a second set of cells including the secondary cell, a frequency range associated with a third set of cells including the secondary cell, or associated with the secondary cell independently.

15. The apparatus of claim 1, wherein the at least one processor is further configured to cause the UE to:
transmit, to the network entity, a capability indication indicating support for separation of the DL activation, the DL deactivation, the UL activation, or the UL deactivation.

16. The apparatus of claim 15, wherein the support for the separation of the DL activation, the DL deactivation, the UL activation, or the UL deactivation is associated with a frequency range.

17. The apparatus of claim 1, wherein a first timeline is associated with the DL deactivation or the DL activation, and wherein a second timeline is associated with the UL deactivation or the UL activation.

18. The apparatus of claim 1, wherein the uplink deactivation is associated with supplementary uplink based on dynamic signaling.

19. A method for wireless communication performed by a user equipment (UE), comprising:
receiving, from a network entity, at least one of a downlink (DL) activation, a DL deactivation, a uplink (UL) activation, or an UL deactivation for a secondary cell, the DL activation, the DL deactivation, the UL activation, or the UL deactivation being separate from each other; and
communicating with the secondary cell based on the DL activation, the DL deactivation, the UL activation, or the UL deactivation.

20. An apparatus for wireless communication at a network entity, comprising:
at least one memory; and
at least one processor coupled to the at least one memory, based at least in part on information stored in the at least one memory, the at least one processor is configured to cause the network entity to:
transmit at least one of a downlink (DL) activation, a DL deactivation, a uplink (UL) activation, or an UL deactivation for a secondary cell, the DL activation, the DL deactivation, the UL activation, or the UL deactivation being separate from each other; and
communicate with a user equipment (UE) via the secondary cell based on the DL activation, the DL deactivation, the UL activation, or the UL deactivation.
